(19) United States
(12) Patent Application Publication
(10) Pub. No.: US 2026/0349541 A1
(43) Pub. Date: Nov. 5, 2026

(54) SCROLL WHEEL ASSEMBLY WITH SPACED ENCODER

(71) Applicant: Microsoft Technology Licensing, LLC, Redmond, WA (US)

(72) Inventors: Max Robert RICHTER, Auburn, WA (US); Benjamin Uriel Sherrett TEMPLE, Redmond, OR (US); Daniel James FAULKNER, Portland, OR (US); Christopher Erol OGUT, Vancouver, WA (US); Daniel Calvert CANFIELD, McMinnville, OR (US); Kent Allen CAMPBELL, Issaquah, WA (US); Isadora Helena PEREIRA COSTA, Seattle, WA (US)

(73) Assignee: Microsoft Technology Licensing, LLC, Redmond, WA (US)

(21) Appl. No.: 19/199,278

(22) Filed: May 5, 2025

(51) Int. Cl. G06F 3/0362; A63F 13/24

(52) U.S. Cl. CPC G06F 3/0362; A63F 13/24

(57) ABSTRACT

A scroll wheel assembly for an input device comprises a housing comprising a face plate that defines an aperture. A scroll wheel protrudes from the aperture, and a shaft is coupled to the scroll wheel and extends from the housing. A rotary encoder is spaced from the housing and coupled to the shaft.

### BACKGROUND

Input devices can utilize one or more scroll wheels to receive user input. In some devices, space constraints can limit available locations for scroll wheels.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

In some examples, a scroll wheel assembly for an input device comprises a housing comprising a face plate that defines an aperture. A scroll wheel protrudes from the aperture and a shaft is coupled to the scroll wheel and extends from the housing. A rotary encoder is spaced from the housing and coupled to the shaft.

In some examples an input device comprises a scroll wheel assembly, with the scroll wheel assembly comprising a housing comprising a face plate that defines an aperture. A scroll wheel protrudes from the aperture and a shaft is coupled to the scroll wheel and extends from the housing. A rotary encoder is spaced from the housing and coupled to the shaft.

In some examples, an input device comprises a housing comprising a face plate that defines a left aperture and a right aperture. The input device includes a left scroll wheel assembly that comprises a left scroll wheel protruding from the left aperture and coupled to a left shaft extending from a left end of the housing. A left rotary encoder is spaced from the housing and coupled to the left shaft. The input device also includes a right scroll wheel assembly comprising a right scroll wheel protruding from the right aperture and coupled to a right shaft extending from a right end of the housing. A right rotary encoder spaced from the housing and coupled to the right shaft.

### BRIEF DESCRIPTION OF THE DRAWINGS

FIG. 1 depicts an example input device in the form of a game controller that includes a scroll wheel assembly according to examples of the present disclosure.

FIG. 2 is a front perspective view of the scroll wheel assembly of the game controller of FIG. 1 according to examples of the present disclosure.

FIG. 3 is an enlarged, partial front view of a face plate of the scroll wheel assembly of the game controller of FIG. 2.

FIG. 4 shows a partially exploded view of the scroll wheel assembly of the game controller of FIG. 2 according to examples of the present disclosure.

FIG. 5 is a partially exploded view of the scroll wheel assembly of FIG. 4 according to examples of the present disclosure.

FIG. 6 is a rear perspective view of the scroll wheel assembly of the game controller of FIG. 2 according to examples of the present disclosure.

FIG. 7 is front view of the scroll wheel assembly of the game controller of FIG. 2.

### DETAILED DESCRIPTION

Electronic devices such as various input devices can utilize one or more scroll wheels to receive user input. In some devices, space constraints, chassis configurations, other components, and/or design considerations can limit available locations for scroll wheels. In these examples, a scroll wheel may not be implemented or may be positioned in a less desirable location in the device. Additionally, integrating additional components near the scroll wheel can prove challenging.

Accordingly, and to address one or more of these shortcomings, the present disclosure describes scroll wheel assemblies and input devices comprising scroll wheel assemblies that include a rotary encoder coupled to a scroll wheel and spaced from a housing that at least partially encloses the scroll wheel. As will be described in more detail below, the housing comprises a face plate that defines an aperture, and the scroll wheel protrudes from the aperture. A shaft is coupled to the scroll wheel and extends from the housing to the rotary encoder that is spaced from the housing. Advantageously, by utilizing an extended shaft to couple the scroll wheel to the spaced-apart encoder, the scroll wheel can be positioned in space-constrained locations that may not otherwise accommodate a rotary encoder or other components, thereby expanding potential device design and configuration opportunities.

In some examples and as described further below, the housing of an input device comprises a face plate that defines a left aperture and a right aperture. A left scroll wheel assembly comprises a left scroll wheel that protrudes from the left aperture and is coupled to a left shaft extending from a left end of the housing. A left rotary encoder is spaced from the housing and coupled to the left shaft. A right scroll wheel assembly comprises a right scroll wheel that protrudes from the right aperture and is coupled to a right shaft extending from a right end of the housing. A right rotary encoder is spaced from the housing and coupled to the right shaft. With these configurations, and in another potential advantage of the present disclosure described further below, two scroll wheels can be positioned in space-constrained locations that also enable one or more additional components to be located between the left scroll wheel and the right scroll wheel.

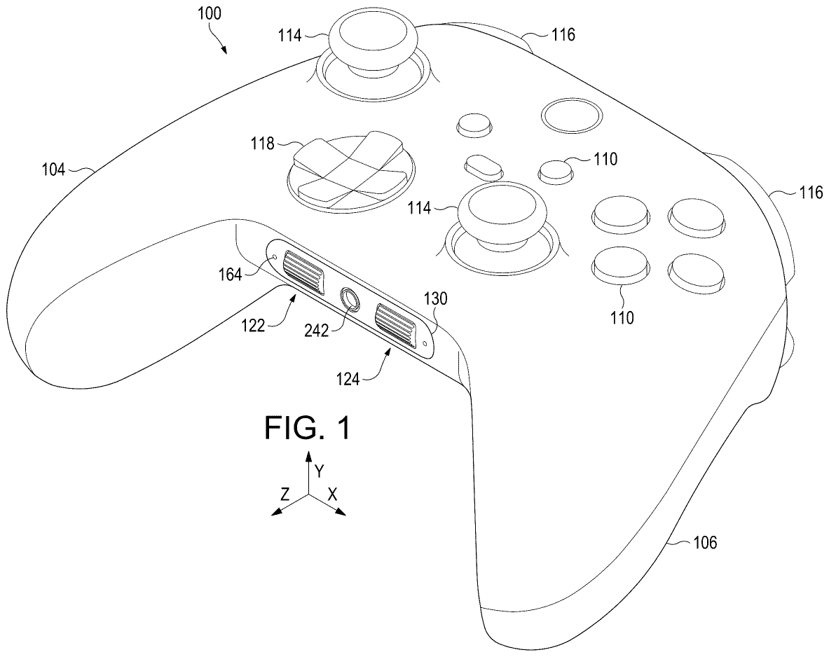

FIG. 1 depicts an example input device in the form of game controller 100. Game controller 100 includes a left handle 104 and right handle 106 configured to be held by a user's left hand and right hand, respectively. In the present example game controller 100 comprises a plurality of input components including buttons 110, thumbsticks 114, bumpers 116, and a direction pad 118. As described in more detail below, and in one potential advantage of the present disclosure, in this example game controller 100 also includes a left scroll wheel assembly 122 and a right scroll wheel assembly 124 that share a common housing. As described in more detail below, in this example left scroll wheel assembly 122 and right scroll wheel assembly 124 utilize the same components and are functionally equivalent in structure.

In other examples, input devices of the present disclosure such as game controller 100 can utilize a single scroll wheel assembly and/or different combinations of other input components. In other examples, scroll wheel assemblies of the present disclosure can be utilized with a wide variety of other types and form factors of input devices, including but not limited to keyboards, mice, gamepads, joysticks, steering wheels, wearable electronic devices, and laptop devices. For example, portable computing devices having thin form factors can benefit from utilizing embodiments of scroll wheel assemblies described herein.

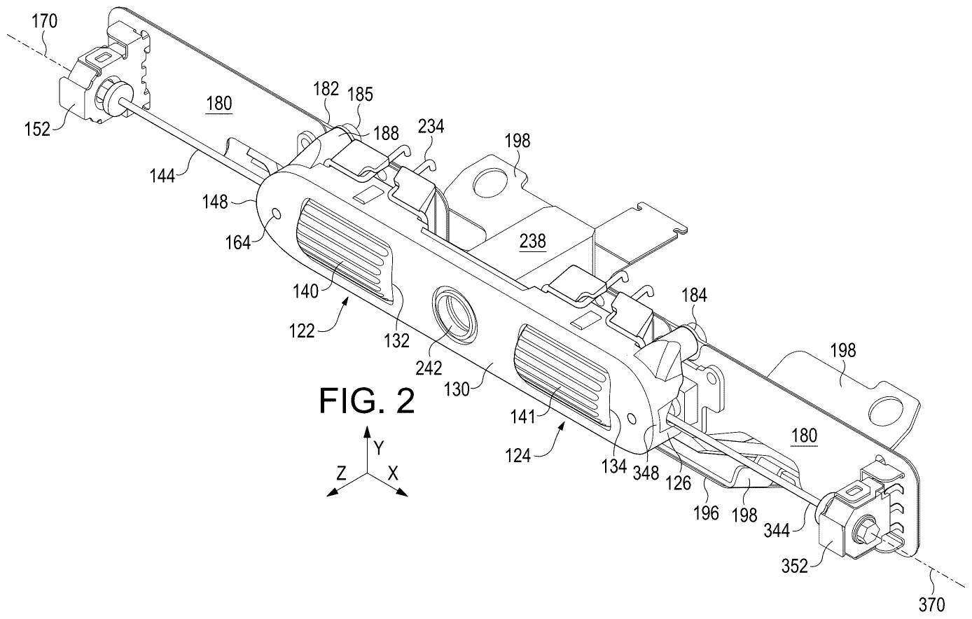

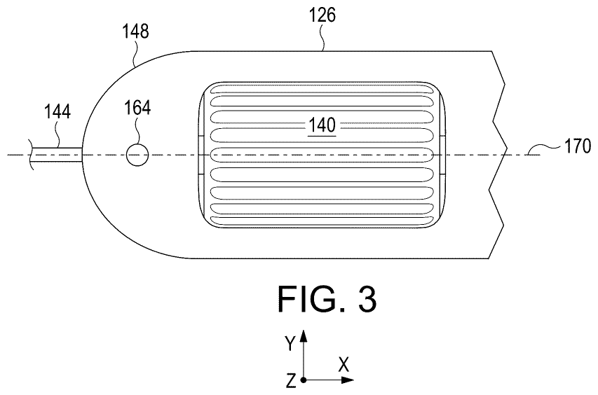

A description of left scroll wheel assembly 122 will now be provided. For purposes of the present disclosure, the components, features, and structures of left scroll wheel assembly 122 and their interrelationships and operation as described herein apply equally to the right scroll wheel assembly 124. In one example and with reference now to FIGS. 2 and 3, scroll wheel assembly 122 includes a housing 126 comprising a face plate 130 that defines a left aperture 132 and a right aperture 134. A left scroll wheel 140 protrudes from the left aperture 132 and is coupled to a left shaft 144. Left shaft 144 extends from a left end 148 of the housing 126. As described further below, and in one potential advantage of the present disclosure, a left rotary encoder 152 is laterally spaced from the left end 148 of housing 126 and is coupled to left shaft 144. In different examples left rotary encoder 152 can take the form of an optical encoder, magnetic encoder, or other suitable electromechanical device that converts the angular position of left shaft 144 to analog or digital output signals.

In other examples of input devices and scroll wheel assemblies of the present disclosure, housing 126 comprises a single aperture from which a single scroll wheel protrudes.

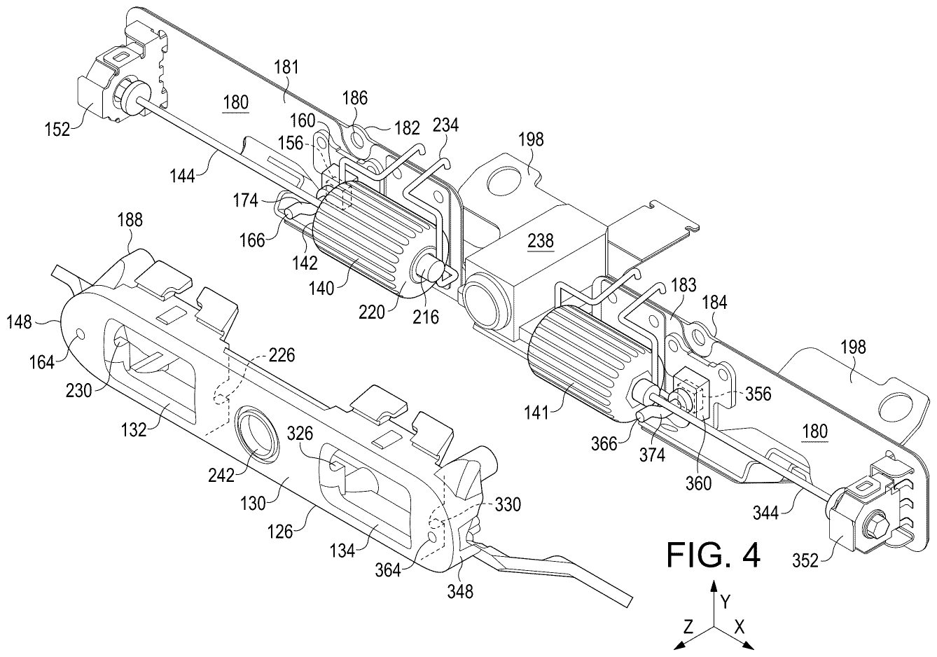

In one potential advantage of the present configuration, by utilizing the extended left shaft 144 to locate the left rotary encoder 152 in a position that is laterally spaced from the left scroll wheel, the present disclosure frees valuable packaging space inside housing 126 that otherwise would be occupied by the encoder, thereby enabling other uses of space within the housing including immediately adjacent to left scroll wheel 140. In this manner, with reference to FIG. 4 and in another potential advantage of the present example, left scroll wheel assembly 122 includes a left light source 156, such as a light emitting diode (LED), positioned between the left scroll wheel 140 and the left rotary encoder 152. In this example, left light source 156 is enclosed in a left containment structure 160 that substantially prevents light bleed from the structure. Advantageously, by laterally spacing the left rotary encoder 152 from the left scroll wheel 140, left light source 156 and left containment structure 160 can be located adjacent to the outer end 142 of left scroll wheel, thereby facilitating the provision of light from the left light source to a left indicator aperture 164 defined in the housing 126 and spaced from the outer end 142 of the left scroll wheel.

In the present example, left light source 156 is coupled to a left light pipe 166 that extends from the light source to the left indicator aperture 164 defined in the housing 126. In this manner, left light source 156 can be selectively activated to provide a visual indication at the left indicator aperture 164 that can correspond to a variety of types of feedback communicated to a user. Additionally, with reference now to FIGS. 2 and 3 and in another potential advantage of the present disclosure, left indicator aperture 164 is coplanar with the left axis of rotation 170 of left scroll wheel 140 and left shaft 144 along the X-axis. In this manner, left indicator aperture 164 is visually aligned with the left axis of rotation 170 of the left scroll wheel 140 to provide a pleasing visual appearance to a user.

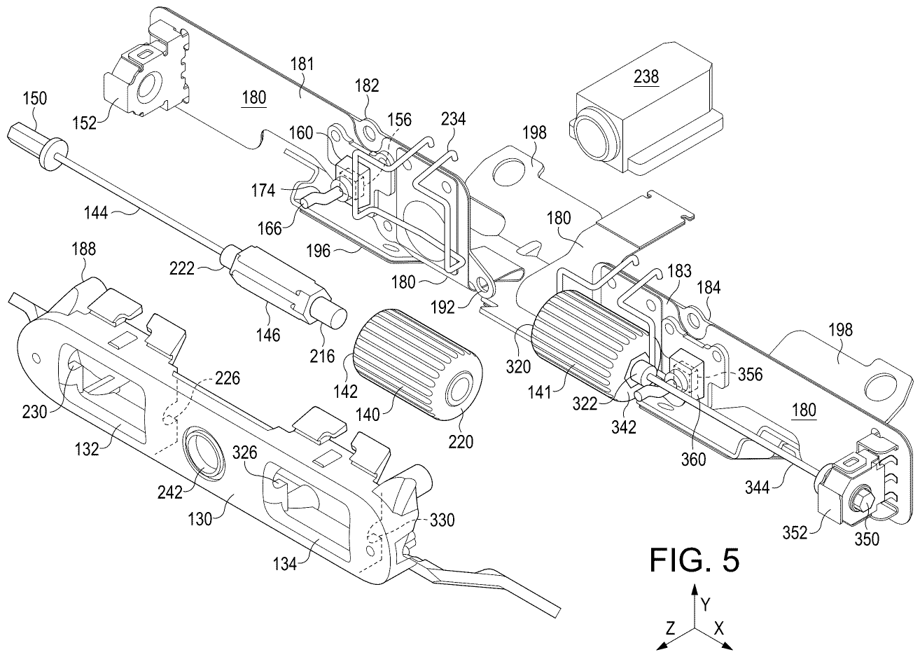

As shown in FIGS. 4 and 5, to achieve the coplanar alignment of the left indicator aperture 164 with the left axis of rotation 170 of left scroll wheel 140 and left shaft 144 along the X-axis, left light source 156 is located offset from the left indicator aperture 164 in the negative Y-axis direction. Further, left light pipe 166 comprises an arcuate portion 174 that travels at least partially in the positive Y-axis direction to bend at least partially around the left shaft 144, after which the light pipe extends in the positive Z-axis direction and is coupled to the left indicator aperture 164. Advantageously, by locating the left light source 156 and utilizing an arcuate light pipe in this manner, left indicator aperture 164 can be positioned coplanar with the left axis of rotation 170 of left scroll wheel 140 and left shaft 144 along the X-axis.

As described in more detail below, in the present example left scroll wheel assembly 122 and right scroll wheel assembly 124 each utilize a single flexible printed circuit 180 to which components of the assemblies are mounted. With reference to FIG. 4, an upper left portion 181 of flexible printed circuit 180 is affixed to a left stiffener plate 182, and an upper right portion 183 is affixed to a right stiffener plate 184. Left light source 156 described above is mounted to a proximal end of the upper left portion 181 of flexible printed circuit 180, and left rotary encoder 152 is mounted to a distal end of the upper left portion 181 spaced from the light source and proximal end of the upper left portion.

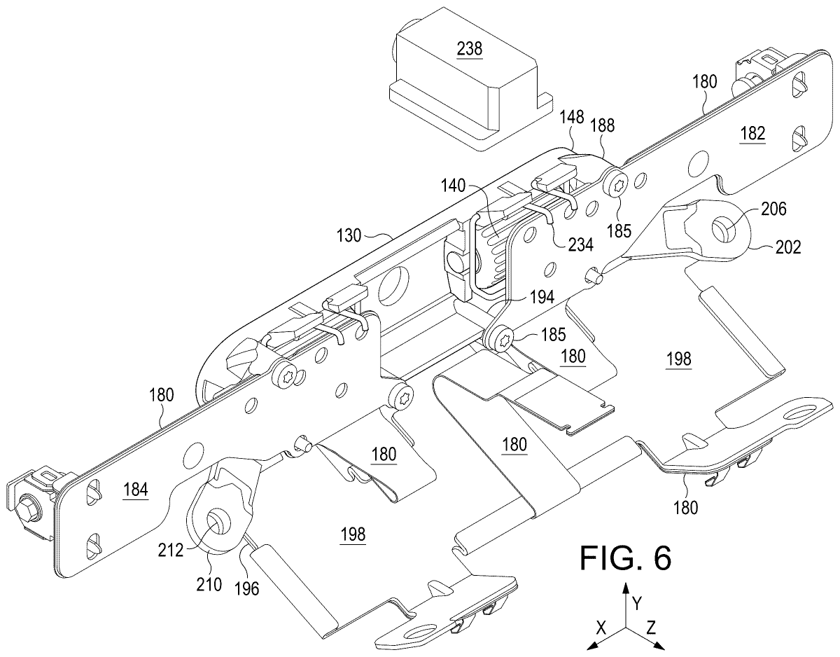

As described further below, housing 126 is mounted to left stiffener plate 182 and right stiffener plate 184 to provide a stable base in which left scroll wheel 140 and right scroll wheel 141 can be rotatably mounted. In this example and with reference to FIGS. 2 and 4, a bolt 185 extends through an upper aperture 186 in left stiffener plate 182 and into an upper receiving post 188 extending from housing 126 to removably affix housing to the stiffener plate. Additionally and with reference also to FIGS. 5 and 6, another bolt 185 extends through a lower aperture 192 in left stiffener plate 182 and into a lower receiving post 194 extending from housing 126 to removably affix the housing to the stiffener plate. Housing 126 is mounted to right stiffener plate 184 in a similar manner.

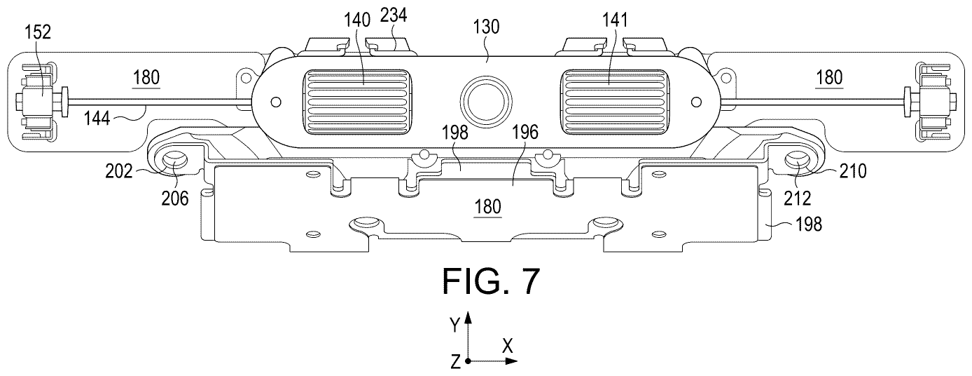

With reference now to FIGS. 6 and 7, the flexible printed circuit 180 comprises a distal portion 196 affixed to a bracket 198, with housing 126 also mounted to bracket 198. In this example, a bolt (not shown) extends through a left upper aperture 202 in bracket 198 and through a left lower housing aperture 206 defined in a left lower extension of housing 126 to removably affix housing to the bracket. Similarly, another bolt (not shown) extends through a right upper aperture 210 in bracket 198 and through a right lower housing aperture 212 defined in a right lower extension of housing 126 to removably affix housing to the bracket.

With reference to FIGS. 4 and 5 and in another potential advantage of the present disclosure, left scroll wheel 140 is removably coupled to a wheel end 146 of left shaft 144. In the present example, left scroll wheel 140 receives a keyed portion of wheel end 146 of left shaft 144 in a press-fit engagement to removably affix the left scroll wheel to the left shaft. Advantageously, providing a removable coupling between the left scroll wheel 140 and left shaft 144 enables easy replacement of one type or configuration of left scroll wheel with a different type or configuration of left scroll wheel. For example, left scroll wheels 140 that are fabricated from different materials, such as metal or plastic, have different colors, surface finishes, surface textures, or other aspects, can be interchangeably utilized with left shaft 144 and the configurations of the present disclosure. In some examples the encoder end 150 of left shaft 144 also is removably coupled to left rotary encoder 152 to further facilitate easy disassembly, replacement of different left scroll wheels 140 on the left shaft, and reassembly of the left scroll wheel assembly 122.

Additionally and as described further below, components associated with positioning and retaining left scroll wheel 140 for rotational and translational movement within housing 126 are easily decoupled from the left scroll wheel, thereby further enabling easy replacement and customization of different scroll wheels. In the present example and with reference to FIGS. 4 and 5, left shaft 144 comprises an inner bearing portion 216 that protrudes from the inner end 220 of the left scroll wheel 140 and an outer bearing portion 222 that protrudes from the outer end 142 of the left scroll wheel. The inner bearing portion 216 is rotatably received in an inner notch 226 defined in housing 126, and the outer bearing portion 222 is rotatably received in an outer notch 230 defined in the housing. A spring 234 is biased against the inner bearing portion 216 and outer bearing portion 222 to retain these portions against the inner notch 226 and outer notch 230 while also enabling rotation of these portions and attached left scroll wheel. Advantageously, these components associated with positioning and rotatably retaining left scroll wheel 140 are easily decoupled from the left scroll wheel, thereby further enabling a simple disassembly and replacement of the scroll wheel.

As noted above, and in one potential advantage of the present disclosure, left scroll wheel assembly 122 and right scroll wheel assembly 124 share common housing 126. Advantageously and as described in more detail below, the configurations of housing 126, left scroll wheel assembly 122, and right scroll wheel assembly 124 enable the two scroll wheel assemblies to be positioned in game controller 100 for easy and convenient access by a user's left and right thumbs, respectively, while also creating space within the housing for an electromechanical component located at least partially between left scroll wheel and right scroll wheel. Additionally, the above-described components, features, and structures of left scroll wheel assembly 122 and their interrelationships and operation apply equally to the right scroll wheel assembly 124. Accordingly, a simplified description of the components, features, and structures of right scroll wheel assembly 124 will now be provided.

With reference to FIGS. 2 and 4, right scroll wheel 141 protrudes from the right aperture 134 and is coupled to a right shaft 344 extending from a right end 348 of the housing 126. A right rotary encoder 352 is laterally spaced from the right end 348 of housing 126 and is coupled to right shaft 344. As noted above with respect to left shaft 144 and left rotary encoder 152, by utilizing the extended right shaft 344 to locate the right rotary encoder 352 in a position that is laterally spaced from the right scroll wheel 141, the present disclosure frees valuable packaging space inside housing 126 otherwise occupied by the encoder, thereby enabling other uses of space within the housing including immediately adjacent to right scroll wheel 141.

In this manner and with reference to FIG. 4, right scroll wheel assembly 124 includes a right light source 356, such as a light emitting diode (LED), positioned between the right scroll wheel 141 and the right rotary encoder 352. As with left light source 156, in this example right light source 356 is enclosed in a containment structure 360 that substantially prevents light bleed from the structure. Advantageously, by laterally spacing the right rotary encoder 356 from the right scroll wheel 141, right light source 356 and right containment structure 360 can be located adjacent to the outer end of right scroll wheel, thereby facilitating the provision of light from the right light source to a right indicator aperture 364 defined in housing 126 and spaced from the outer end of the right scroll wheel 141.

Right light source 356 is coupled to a right light pipe 366 that extends from the light source to the right indicator aperture 364. As with left indicator aperture 164 described above, right indicator aperture 364 is coplanar with the right axis of rotation 370 of right scroll wheel 141 and right shaft 344 along the X-axis (see FIG. 2). In this manner, right indicator aperture 364 is visually aligned with the right axis of rotation 370 of right scroll wheel 141 to provide a pleasing visual appearance to a user.

Additionally, in this example the right axis of rotation 370 of right scroll wheel 141 and right shaft 344 is substantially colinear with the left axis of rotation 170 of the left scroll wheel 140 and left shaft 144. Advantageously and in this manner, this configuration positions left scroll wheel 140 and right scroll wheel 141 for rotation about substantially the same axis and enables both scroll wheels to extend by substantially the same distance from their respective apertures in housing 126. It follows that this configuration advantageously locates left scroll wheel 140 and right scroll wheel 141 in substantially the same position and orientation with respect to left handle 104 and right handle 106 of game controller 100, thereby providing a substantially similar experience for a user reaching either their left or right thumb to engage with the left scroll wheel or right scroll wheel.

With reference to FIG. 4 and as with left light source 156 described above, right light source 356 is located offset from the right indicator aperture 364 in the negative Y-axis direction, and right light pipe 366 comprises an arcuate portion 374 that travels at least partially in the positive Y-axis direction to bend at least partially around the right shaft 344 and couple to the right indicator aperture 364.

As noted above, right scroll wheel assembly 124 also utilizes the flexible printed circuit 180 to which components of the assembly are mounted. Right light source 356 is mounted to a proximal end of the upper right portion 183 of flexible printed circuit 180, and right rotary encoder 352 is mounted to a distal end of the upper right portion 183 spaced from the light source and proximal end.

In the same manner as left scroll wheel 140 described above, right scroll wheel 141 is removably coupled to a wheel end of right shaft 344 by receiving a keyed portion of right shaft 344 in a press-fit engagement to removably affix the right scroll wheel to the right shaft. As noted above, providing a removable coupling between the right scroll wheel 141 and right shaft 344 enables easy replacement of one type or configuration of left scroll wheel with a different type or configuration of left scroll wheel. In some examples the encoder end 350 of right shaft 344 also is removably coupled to right rotary encoder 352 to further facilitate the easy replacement of different right scroll wheels on the right shaft.

As described above with respect to left scroll wheel 140, components associated with positioning and retaining right scroll wheel 141 for rotational and translational movement within housing 126 are easily decoupled from the right scroll wheel, thereby further enabling easy replacement and customization of different scroll wheels. Like left shaft 144 described above, right shaft 344 comprises an inner bearing portion that protrudes from the inner end 320 of the right scroll wheel 141 and an outer bearing portion 322 that protrudes from the outer end 142 of the right scroll wheel. The inner bearing portion is rotatably received in an inner notch 326 defined in housing 126, and the outer bearing portion 322 is rotatably received in an outer notch 230 defined in the housing. As with left shaft 144, spring 234 is biased against the inner bearing portion and outer bearing portion 322 of right shaft 344 to retain these portions against the inner notch 326 and outer notch 330 while also enabling rotation of these portions and attached left scroll wheel.

As noted above, the configurations of housing 126, left scroll wheel assembly 122, and right scroll wheel assembly 124 advantageously provide space within the housing to locate an electromechanical component at least partially between left scroll wheel 140 and right scroll wheel 141. In the present example and with reference to FIGS. 2 and 4, an electromechanical component 238 in the form of an audio component is located at least partially between the left scroll wheel 140 and the right scroll wheel 141. Additionally, housing 126 comprises a central aperture 242 between the left aperture 132 and the right aperture 134, with the central aperture configured to removably receive a connector, such as an audio jack, that engages with the electromechanical component 238. In other examples, a variety of different electromechanical components or other configurations of components can be located between the left scroll wheel 140 and the right scroll wheel 141.

The following paragraphs provide additional support for the claims of the application. In one aspect a scroll wheel assembly for an input device comprises a housing comprising a face plate that defines an aperture; a scroll wheel protruding from the aperture; a shaft coupled to the scroll wheel and extending from the housing; and a rotary encoder spaced from the housing and coupled to the shaft. The scroll wheel assembly may additionally or alternatively include a light source between the scroll wheel and the rotary encoder. The scroll wheel assembly may additionally or alternatively include a light pipe extending from the light source to an indicator aperture defined in the housing. The scroll wheel assembly may additionally or alternatively include wherein the light pipe comprises an arcuate portion that bends at least partially around the shaft. The scroll wheel assembly may additionally or alternatively include wherein the rotary encoder is mounted to a flexible printed circuit that is affixed to a stiffener plate. The scroll wheel assembly may additionally or alternatively include wherein the housing is mounted to the stiffener plate. The scroll wheel assembly may additionally or alternatively include wherein the flexible printed circuit comprises a distal portion affixed to a bracket, and the housing is also mounted to the bracket. The scroll wheel assembly may additionally or alternatively include wherein the scroll wheel is removably coupled to a wheel end of the shaft.

Another aspect provides an input device comprising a scroll wheel assembly, the scroll wheel assembly comprising a housing comprising a face plate that defines an aperture; a scroll wheel protruding from the aperture; a shaft coupled to the scroll wheel and extending from the housing; and a rotary encoder spaced from the housing and coupled to the shaft. The input device may additionally or alternatively include a light source between the scroll wheel and the rotary encoder. The input device may additionally or alternatively include a light pipe extending from the light source to an indicator aperture defined in the housing. The input device may additionally or alternatively include wherein the light pipe comprises an arcuate portion that bends at least partially around the shaft. The input device may additionally or alternatively include wherein the rotary encoder is mounted to a flexible printed circuit that is affixed to a stiffener plate. The input device may additionally or alternatively include wherein the housing is mounted to the stiffener plate. The input device may additionally or alternatively include wherein the flexible printed circuit comprises a distal portion affixed to a bracket, and the housing is also mounted to the bracket.

Another aspect provides an input device comprising a housing comprising a face plate that defines a left aperture and a right aperture; a left scroll wheel assembly comprising: a left scroll wheel protruding from the left aperture and coupled to a left shaft extending from a left end of the housing; a left rotary encoder spaced from the housing and coupled to the left shaft; and a right scroll wheel assembly comprising: a right scroll wheel protruding from the right aperture and coupled to a right shaft extending from a right end of the housing; and a right rotary encoder spaced from the housing and coupled to the right shaft. The input device may additionally or alternatively include an electromechanical component located at least partially between the left scroll wheel and the right scroll wheel. The input device may additionally or alternatively include wherein the housing comprises a central aperture between the left aperture and the right aperture, the central aperture configured to removably receive a connector that engages with the electromechanical component. The input device may additionally or alternatively include wherein the right scroll wheel has a right axis of rotation that is substantially colinear with a left axis of rotation of the left scroll wheel. The input device may additionally or alternatively include wherein the left rotary encoder is mounted to a first portion of a flexible printed circuit that is affixed to a left stiffener plate, and the right rotary encoder is mounted to a second portion of the flexible printed circuit that is affixed to a right stiffener plate.

It will be understood that the configurations and/or approaches described herein are exemplary in nature, and that these specific embodiments or examples are not to be considered in a limiting sense, because numerous variations are possible.

The subject matter of the present disclosure includes all novel and non-obvious combinations and sub-combinations of the various processes, systems and configurations, and other features, functions, acts, and/or properties disclosed herein, as well as any and all equivalents thereof.

The claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure. As used herein, the phrase “and/or” means any or all of multiple stated possibilities.

1. A scroll wheel assembly for an input device, the scroll wheel assembly comprising:
a housing comprising a face plate that defines an aperture;
a scroll wheel protruding from the aperture;
a shaft coupled to the scroll wheel and extending from the housing; and
a rotary encoder spaced from and exterior to the housing and coupled to the shaft.

2. The scroll wheel assembly of claim 1, further comprising a light source between the scroll wheel and the rotary encoder.

3. The scroll wheel assembly of claim 2, further comprising a light pipe extending from the light source to an indicator aperture defined in the housing.

4. The scroll wheel assembly of claim 3, wherein the light pipe comprises an arcuate portion that bends at least partially around the shaft.

5. The scroll wheel assembly of claim 1, wherein the rotary encoder is mounted to a flexible printed circuit that is affixed to a stiffener plate.

6. The scroll wheel assembly of claim 5, wherein the housing is mounted to the stiffener plate.

7. The scroll wheel assembly of claim 6, wherein the flexible printed circuit comprises a distal portion affixed to a bracket, and the housing is also mounted to the bracket.

8. The scroll wheel assembly of claim 1, wherein the scroll wheel is removably coupled to a wheel end of the shaft.

9. An input device comprising a scroll wheel assembly, the scroll wheel assembly comprising:
a housing comprising a face plate that defines an aperture;
a scroll wheel protruding from the aperture;
a shaft coupled to the scroll wheel and extending from the housing; and
a rotary encoder spaced from and exterior to the housing and coupled to the shaft.

10. The input device of claim 9, further comprising a light source between the scroll wheel and the rotary encoder.

11. The input device of claim 10, further comprising a light pipe extending from the light source to an indicator aperture defined in the housing.

12. The input device of claim 11, wherein the light pipe comprises an arcuate portion that bends at least partially around the shaft.

13. The input device of claim 9, wherein the rotary encoder is mounted to a flexible printed circuit that is affixed to a stiffener plate.

14. The input device of claim 13, wherein the housing is mounted to the stiffener plate.

15. The input device of claim 14, wherein the flexible printed circuit comprises a distal portion affixed to a bracket, and the housing is also mounted to the bracket.

16. An input device comprising:
a housing comprising a face plate that defines a left aperture and a right aperture;
a left scroll wheel assembly comprising:
a left scroll wheel protruding from the left aperture and coupled to a left shaft extending from a left end of the housing;
a left rotary encoder spaced from and exterior to the housing and coupled to the left shaft; and
a right scroll wheel assembly comprising:
a right scroll wheel protruding from the right aperture and coupled to a right shaft extending from a right end of the housing; and
a right rotary encoder spaced from and exterior to the housing and coupled to the right shaft.

17. The input device of claim 16, further comprising an electromechanical component located at least partially between the left scroll wheel and the right scroll wheel.

18. The input device of claim 17, wherein the housing comprises a central aperture between the left aperture and the right aperture, the central aperture configured to removably receive a connector that engages with the electromechanical component.

19. The input device of claim 16, wherein the right scroll wheel has a right axis of rotation that is substantially colinear with a left axis of rotation of the left scroll wheel.

20. The input device of claim 16, wherein the left rotary encoder is mounted to a first portion of a flexible printed circuit that is affixed to a left stiffener plate, and the right rotary encoder is mounted to a second portion of the flexible printed circuit that is affixed to a right stiffener plate.
